(19) United States
(12) Patent Application Publication
(10) Pub. No.: US 2023/0381934 A1
(43) Pub. Date: Nov. 30, 2023

(54) Method for Operating a Hand-Held Power Tool

(71) Applicant: Robert Bosch GmbH, Stuttgart (DE)

(72) Inventors: Simon Erbele, Nufringen (DE); Stefan Mock, Remshalden (DE); Wolfgang Herberger, Stuttgart (DE); Jasmin Giessler, Steinach (DE)

(21) Appl. No.: 18/249,713

(22) PCT Filed: Oct. 1, 2021
(86) PCT No.: PCT/EP2021/077133

§ 371 Date: Apr. 19, 2023

(30) Foreign Application Priority Data
Oct. 21, 2020 (DE) 10 2020 213 271.2

(51) Int. Cl. B25B 23/147

(52) U.S. Cl. CPC B25B 23/1475

(57) ABSTRACT

A method for operating a hand-held power tool is disclosed, with the hand-held power tool including an electric motor. The method includes step (S1) providing comparative information, having the steps of (S1a) providing at least one model signal waveform, said model signal waveform being assignable to the work progress of the hand-held power tool, and (S1b) providing a threshold of a match. The method further includes step (S2) ascertaining a signal of an operational variable of the electric motor. The method also includes step (S3) analyzing the comparative information and the signal of an operational variable, having the steps of (S3a) comparing the signal of the operational variable with the model signal waveform and ascertaining a match signal from the comparison, and (S3b) ascertaining a match evaluation, said match evaluation being carried out at least partly using the threshold of the match and using the match signal. In addition, the method includes step (S4) detecting the work progress at least partly using the match evaluation ascertained in step S3, said comparative information being provided at least partly on the basis of an automatic evaluation of the match signal. An associated hand-held power tool is also disclosed.

The invention relates to a method for operating a hand-held power tool and a hand-held power tool configured so as to carry out the method.

### PRIOR ART

From the prior art, see for example EP 3 381 615 A1, percussive screwdrivers for tightening screw elements, such as threaded nuts and screws, are known. For example, a percussive screwdriver of this type includes a structure in which a percussive force in a rotational direction is transferred to a screw element by a rotational percussive force of a hammer. The percussive screwdriver, which has this construction, comprises a motor, a hammer to be driven by the motor, an anvil that is struck by the hammer, and a tool. In the percussive screwdriver, the motor installed in a housing is driven, wherein the hammer is driven by the motor, the anvil is struck by the rotating hammer in turn, and a percussive force is delivered to the tool, wherein two different operating states, namely “no percussive operation” and “percussive operation,” can be distinguished.

From DE 20 2017 0035 90 an electrically driven tool with a percussive mechanism is also known, wherein the hammer is driven by the motor.

When using percussive screwdrivers, a high level of concentration on work progress is required on the user's side in order to ensure that certain machine characteristics, for example the start and end of the percussive mechanism are reacted to accordingly, for example in order to stop the electric motor and/or to carry out a change in the speed via the hand switch. Because it is often not possible for the user to react quickly or adequately enough to a work progress, it can be possible when using percussive screwdrivers to over-tighten screws during screwing-in operations and to drop screws during screwing-out operations when they are screwed out at too high a speed.

It is therefore generally desired to further automate the operation and to take the burden off of the user with correspondingly machine-triggered reactions or routines of the device and thus to reliably achieve reproducible screw-in and screw-out operations of high quality. Examples of such machine-triggered reactions or routines include, for example, shutting down the motor, changing the motor speed, or triggering a warning to the user.

The provision of such intelligent tool functions can be accomplished, among other things, by identifying the currently set operating state. An identification of the latter is carried out in the prior art, independent of determining a work progress or the status of an application, for example by monitoring the operational variables of the electric motor, such as speed and electric motor current. In this context, the operational variables are examined as to whether certain limit values and/or thresholds are achieved. Corresponding evaluation methods operate with absolute thresholds and/or signal gradients.

It is disadvantageous here that a fixed limit value and/or threshold can be perfectly set for practically only one application. As soon as the application case changes, the associated power and/or speed values or their temporal curves and a percussive detection based on the set limit value and/or threshold or their temporal curves no longer functions.

For example, it can be the case that an automatic shutdown based on the detection of percussive operation reliably shuts down at different speed ranges in individual applications when using self-tapping screws, but, in other applications when using self-tapping screws, no shutdown occurs.

In some cases, the user can, for example, adjust the sensitivity of the motor response to the current screwing case by adjusting a parameter. Accordingly, after correct setting of the parameter, the end of a screwing operation can be detected, and a suitable motor response can be triggered. However, adjusting parameters in this way requires some experience with the appropriate hand-held power tool, is time consuming, and does not result in a satisfactory outcome in all cases. It is therefore desirable to facilitate the operation in such a way that no adjustment is required on the part of the user.

In other methods for determining modes of operation for percussive screwdrivers, additional sensors, such as accelerometers, are used in order to use vibrational conditions of the tool to conclude the current mode of operation.

Disadvantages of these methods are additional cost for the sensors, as well as to the robustness of the hand-held power tool, because the number of installed components and electrical connections increases compared to hand-held power tools without this sensor technology.

Furthermore, simple information as to whether or not the percussive system works is not sufficient to be able to make accurate statements about the progress of the work. For example, when screwing in certain wooden screws, the rotary percussive mechanism starts very early, while the screw is not yet fully screwed into the material, but the required torque already exceeds the so-called disengagement torque of the rotary percussive mechanism. Thus, a response purely on the basis of the operating state (percussive operation and no percussive operation) of the rotary mechanism is not sufficient for a correct automatic system function of the tool, for example a shutdown.

In principle, there is the problem of automating operation as far as possible, even in other hand-held power tools, such as percussive drills, so that the invention is not limited to rotary percussive screwdrivers.

### DISCLOSURE OF THE INVENTION

The problem addressed by the invention is to provide an improved method for operating a hand-held power tool compared to the prior art, which at least partly overcomes the aforementioned disadvantages, or at least is an alternative to the prior art. A further problem is to specify a corresponding hand-held power tool.

This problem is solved by means of the respective subject-matter of the independent claims. Advantageous embodiments of the invention are the subject-matter of respectively dependent subclaims.

According to the invention, a method for operating a hand-held power tool with an electric motor is disclosed, wherein the method discloses the following steps:
S1 providing comparative information, having the steps of:
   S1a providing at least one model signal waveform, said model signal waveform being assignable to a work progress of the hand-held power tool, and
   S1b providing a threshold of a match;
S2 ascertaining a signal of an operational variable of the electric motor;
S3 analyzing the comparative information and the signal of an operational variable, having the method steps of:
   S3a comparing the signal of the operational variable with the model signal waveform and ascertaining a match signal from the comparison and
   S3b ascertaining a match evaluation, said match evaluation being carried out at least partly using the threshold of the match and using the match signal; and
S4 detecting the work progress at least partly using the match evaluation ascertained in step S3.

According to the present invention, it is provided that the comparative information is provided at least partly on the basis of an automatic evaluation of the match signal.

The invention facilitates the operation of a hand-held power tool in that no adjustment of parameters is required on the part of a user. Accordingly, the end of a screwing operation can be independently detected by the machine regardless of external circumstances, such as screw type and materials, whereupon in some embodiments of the invention, a suitable routine of the hand-held power tool, such as a motor response, can be triggered in a method step S5, which takes place at least partly on the basis of the work progress detected in method step S4. Advantageously, this functionality is realized without the assistance of an additional hardware component, for example diverse sensors, and is thus only carried out by the analysis of already existing signals, for example the motor speed signal. The need for the user to adjust a parameter is eliminated. Thus, a motor response can be triggered independently, regardless of material and type of screw.

By the method according to the invention, a user of the hand-held power tool is effectively assisted in achieving reproducibly high-quality application results. In particular, it is easier and/or faster for a user to achieve a fully completed work progress with the method according to the invention.

In some embodiments, the percussive screwdriver reacts to a detection of the percussive state and the work progress with the help of finding characteristic signal waveforms.

Through various routines, it is possible to offer the user one or more system functionalities with which he or she can conclude application cases more easily and/or faster.

Some embodiments of the invention can be categorized as follows:
1. Embodiments comprising routines or reactions to “pure” percussive detection;
2. Embodiments comprising routines or responses to non-percussive detection;
3. Embodiments comprising routines or reactions to work progress (percussive evaluation/percussive quality).

All embodiments have the basic advantage that it is possible to conclude application cases as quickly and completely as possible, wherein the user experiences easier work.

As will be appreciated by those skilled in the art, the feature of the model signal waveform includes a signal waveform of a continuous progress of a working operation. In one embodiment, the model signal waveform is a condition-typical model signal waveform that is condition-typical for a particular work progress of the hand-held power tool, for example a screw head resting on a fastening beam, or the free rotation of a loosened screw.

The approach for detecting the work progress via operational variables in the in-tool measured variables, for example the speed of the electric motor, proves to be particularly advantageous, because with this method the work progress is carried out particularly reliably and largely independently of the general operating state of the tool or the application case.

In particular, additional sensor units for sensing the in-tool measured variables are essentially omitted, for example an accelerometer unit, so that substantially exclusively the method according to the invention is used in order to detect the work progress.

In embodiments of the invention, the match signal reflects a constant or variable, particularly time-variable error, which corresponds to a difference between the model signal and the signal of the operational variable.

In one embodiment, the automatic evaluation of the match signal includes ascertaining a characteristic of the match signal, such as that of a gradient, a curvature, or a local or global minimum or maximum. The determination of the characteristic of the match signal is carried out in the mathematical sense, for example by differentiating the match signal one or more times, which is present as a time curve or as a curve over a variable of the electric motor correlating to the time curve. Known methods of numerical differential calculation and curve discussion can be used in this context.

The determination of the match signal can comprise a determination of an appropriately defined error between the model signal and the operational variable signal, optionally as a time curve or as a curve over a variable of the electric motor correlating to the time curve.

In so doing, the threshold of the match can be determined, for example estimated, based at least partly on the characteristic of the match signal. It is not necessary for there to be an operational adjustment of the threshold of the match or on the part of a user.

Furthermore, the match evaluation in step S3b can be based at least partly on a frequency of the signal of the operational variable. In this embodiment, in addition to the match signal, the frequency of the measured speed signal is additionally ascertained, for example calculated or measured, for example in percussive operation. This frequency varies during the screwing operation, so it can be used in order to detect a work progress of the hand-held power tool, for example the end of a screwing case, with the aid of the match signal, and to trigger a suitable motor response.

In embodiments of the invention, it is ascertained whether this frequency exceeds or falls below a frequency threshold, so that the match evaluation in method step S3b is carried out at least partly as a function of a frequency threshold. If the frequency exceeds the frequency threshold, the frequency of the signal of the operational variable is considered in the match evaluation in step S3b.

In certain embodiments, the match evaluation in step S3b is based at least partly on a logical linkage of the match signal and the frequency of the signal of the operational variable, for example an “AND,” “AND NOT,” or “OR” link.

In a further embodiment, the match evaluation in step S3b is based at least partly on a sum signal of the match signal and the frequency of the signal of the operational variable.

In a further embodiment, the match evaluation in step S3b can be ascertained at least partly based on blurred amounts or belonging functions (weight functions), cf. fuzzy logic.

In one embodiment, the first routine carried out in step S5 comprises the stopping the electric motor, taking into account at least one parameter that is defined and/or specifiable, in particular specifiable by a user of the hand-held power tool. Examples of such a parameter include a period of time, a number of revolutions of the electric motor, a number of revolutions of the toolholder, an angle of rotation of the electric motor, and a number of impacts of the percussive system of the hand-held power tool.

In a further embodiment, the first routine comprises a change, in particular a reduction and/or an increase, of a speed of the electric motor. Such a change in the speed of the electric motor can be achieved, for example, by a change in motor current, motor voltage, battery current, or battery voltage, or by a combination of these measures.

Preferably, an amplitude of change in the speed of the electric motor can be defined by a user of the hand-held power tool. Alternatively or additionally, the change in the speed of the electric motor can also be specified by a target value. In this context, the term amplitude is also generally understood in terms of an amount of the change and is not exclusively associated with cyclic processes.

In one embodiment, the change in the speed of the electric motor occurs repeatedly and/or dynamically, in particular staggered over time and/or along a characteristic curve of the speed change and/or using the work progress of the hand-held power tool.

In one embodiment, the first routine comprises adjusting a speed value of the electric motor and keeping the speed value substantially constant. As soon as the first routine is carried out, the speed value is set. In so doing, the speed value is kept substantially constant, such that the electric motor rotates substantially at the speed of the set speed value. In this context, “keep substantially constant” should be understood to mean that small speed fluctuations in the region of 1% to 25% are possible around the set speed value for the speed. It is conceivable that the user can set the speed value. It is also possible for the speed value to be set at the factory. Adjusting and keeping the speed value substantially constant allows for a tightening of screw elements with lower fluctuations of a screw biasing force.

Preferably, a work progress of the first routine is output to a user of the hand-held power tool using a output apparatus of the hand-held power tool. The phrase “output by means of the output apparatus” can be understood in particular to mean the display or documentation of the work progress. Documentation can also be the evaluation and/or storage of work progress. This includes, for example, storing multiple screwing operations also in a memory.

In one embodiment, the first routine and/or characteristic parameters of the first routine can be adjusted and/or displayed by a user via an application software (“app”) or a user interface (“human-machine interface,” “HMI”).

Furthermore, in one embodiment, the HMI can be arranged on the machine itself, while in other embodiments, the HMI can be arranged on external devices, for example, a smartphone, a tablet, or a computer.

In one embodiment of the invention, the first routine comprises optical, acoustic, and/or haptic feedback to a user.

In one embodiment, the method comprises a method step AM, in which an upper speed limit of the electric motor is set. The method step AM can be preceded by method step S1 or can follow another method step. The upper speed limit of the electric motor substantially limits an available speed of the electric motor relative to a maximum speed of the electric motor. The upper speed limit can be in a range of 20% to 100%, particularly in a range of 30% to 95%, very particularly in a range of 50% to 85%, of the maximum speed of the electric motor. It is conceivable that the user can set the upper speed limit or that the upper speed limit is factory-specified. Setting the upper speed limit allows for screwing in screw elements with lower fluctuations in a screw biasing force.

It is conceivable that the upper speed limit of the method step AM will remain set until the first routine in method step S5. It is possible that the upper speed limit can remain set until one of the method steps S1 to S4. Thus, it is possible that the upper speed limit of the method step AM can remain set until method step S5 and, during the first routine, an increased speed is set compared to the upper speed limit.

Setting the electric motor upper speed limit allows for a tightening of screw elements with less fluctuations in a screw biasing force.

Preferably, the model signal waveform is a vibration curve, such as a vibration curve around a mean, in particular a substantially trigonometric vibration curve. For example, the model signal waveform can represent an ideal percussive operation of the hammer on the anvil of the rotary percussive mechanism, wherein the ideal percussive operation is preferably a strike without further rotation of the tool spindle of the hand-held power tool.

In principle, different operational variables can come into consideration as operational variables, which are incorporated via a suitable measurement transducer. In this respect, it is particularly advantageous that no additional sensor is necessary in accordance with the present invention, because various sensors, for example for speed monitoring, preferably Hall sensors, are already installed in electric motors.

Advantageously, the operational variable is a speed of the electric motor or an operational variable correlating to the speed. For example, the rigid gear ratio of the electric motor to the percussive mechanism results in a direct dependence of the motor speed on the frequency of the percussion. A further conceivable operational variable correlating to the speed is the motor current. As an operational variable of the electric motor, a motor voltage, a Hall signal of the motor, a battery current, or a battery voltage are also conceivable, wherein an acceleration of the electric motor, an acceleration of a toolholder, or a sound signal of a percussive system of the hand-held power tool is also conceivable as the operational variable.

Preferably, the comparison of the signal of the operational variable to the model signal waveform in step S3a includes the use of a frequency-based comparison method and/or a comparative comparison method.

In this case, the decision as to whether a work progress to be detected has been identified in the signal of the operational variable can be made at least partly by means of the frequency-based comparison method, in particular a band-pass filtering and/or a frequency analysis.

In one embodiment, the frequency-based comparison method comprises at least band-pass filtering and/or frequency analysis.

In one embodiment, the comparative comparison method comprises at least a parameter estimate and/or a cross-correlation.

The measured signal of the operational variable can be compared to the model signal waveform by means of the comparative comparison method. The measured signal of the operational variable is ascertained such that it has substantially the same finite signal length as that of the model signal waveform. The comparison of the model signal waveform to the measured signal of the operational variable can be output as a signal of a finite length, in particular discrete or continuous. Depending on a degree of matching or a deviation of the comparison, a result can be output as to whether the work progress to be detected, in particular the ideal strike, is present without further rotation of the struck element.

In method step S4 of the method according to the invention, the detection of the work progress can occur at least partly on the basis of the cross-correlation of the model signal waveform to the measured signal of the operational variable.

In a further embodiment, the hand-held power tool is a percussive screwdriver, in particular a rotary percussive screwdriver, and the work progress is a start or end of a percussive operation, in particular a rotary percussive operation.

In particular, in method step S1, the model signal waveform can be set variably, in particular by a user. Here, the model signal waveform is associated with the work progress to be detected so that the user can specify the work progress to be detected.

Advantageously, the model signal waveform is predefined in method step S1, in particular at the factory. In principle, it is conceivable that the model signal waveform is deposited or stored on the device, alternatively and/or additionally provided to the hand-held power tool, in particular from an external data device.

In a further embodiment, the signal of the operational variable is incorporated in method step S2 as a time curve of measured values of the operational variable, or is incorporated as measured values of the operational variable as a variable of the electric motor that correlates to the time curve, for example an acceleration, a jerking, in particular of a higher order, a power, an energy, a rotational angle of the electric motor, a rotational angle of the toolholder, or a frequency.

In the last mentioned embodiment, it can be ensured that a consistent periodicity of the signal to be investigated results, regardless of the motor speed.

If the signal of the operational variable is incorporated in method step S2 as a time curve of measured values of the operational variable, then, in a method step S2a following the method step S2, there is, on the basis of a rigid gear ratio of the transmission, a transformation of the time curve of the measured values of the operational variable into a curve of the measured values of the operational variable as a variable of the electric motor correlated with the time curve. Thus, the same advantages result as in the direct receipt of the signal of the operational variable via the time.

The method according to the invention thus allows the detection of the work progress regardless of at least one target speed of the electric motor, at least one start-up characteristic of the electric motor, and/or at least one state of charge of a power supply, in particular a battery, of the hand-held power tool.

The signal of the operational variable is to be considered a temporal sequence of measured values here. Alternatively and/or additionally, the signal of the operational variable can also be a frequency spectrum. Alternatively and/or additionally, the signal of the operational variable can also be reworked, for example smoothed, filtered, fitted, and the like.

In a further embodiment, the signal of the operational variable is stored in a memory, preferably a ring memory, in particular of the hand-held power tool, as a result of measured values.

In one method step, the work step to be detected is identified by means of fewer than ten strikes of a percussive system of the hand-held power tool, in particular fewer than ten percussive oscillation periods of the electric motor, preferably fewer than six strikes of a percussive system of the hand-held power tool, in particular fewer than six percussive oscillation periods of the electric motor, very preferably fewer than four strikes of a percussive system, in particular fewer than four percussive oscillation periods of the electric motor. In this context, an axial, radial, tangential, and/or circumferential strike of a percussive object, in particular a hammer, on a percussive body, in particular an anvil, is to be understood as a strike of the percussive mechanism. The percussive oscillation period of the electric motor is correlated to the operational variable of the electric motor. A percussive oscillation period of the electric motor can be ascertained based on fluctuations of the operational variable in the signal of the operational variable.

A further subject-matter of the invention is a hand-held power tool having an electric motor, a measurement transducer of an operational variable of the electric motor, and a control unit, wherein the hand-held power tool is advantageously a percussive screwdriver, in particular a rotary percussive screwdriver, and the hand-held power tool is configured so as to carry out the method described above.

Preferably, the work progress to be detected corresponds to a strike without continuing to rotate a toolholder of the hand-held power tool.

The electric motor of the hand-held power tool sets an input spindle into rotation, and an output spindle is connected to the toolholder. An anvil is rotationally connected to the output spindle, and a hammer is connected to the input spindle in such a way that, as a result of the rotational movement of the input spindle, it performs an intermittent movement in the axial direction of the input spindle as well as an intermittent rotational movement about the input spindle, wherein the hammer thus intermittently strikes the anvil and thus exerts a percussive and rotational impulse on the anvil and thus on the output spindle. A first sensor transmits a first signal to the control unit, for example to ascertain a motor rotary angle. Furthermore, a second sensor can transmit a second signal to the control unit in order to ascertain a motor speed.

Advantageously, the hand-held power tool has a memory unit in which various values can be stored.

In a further embodiment, the hand-held power tool is a battery-operated hand-held power tool, in particular a battery-operated percussive screwdriver. In this way, a flexible and off-grid use of the hand-held power tool is ensured.

Advantageously, the hand-held power tool is a percussive screwdriver, in particular a rotary percussive screwdriver, and the work progress to be detected is a strike of the rotary mechanism without further rotation of the struck element or toolholder.

For example, the identification of strikes of the percussive system of the hand-held power tool, in particular the percussive oscillation periods of the electric motor, can be accomplished by using a fast-fitting algorithm in order to enable an evaluation of percussive detection within fewer than 100 ms, particularly fewer than 60 ms, very particularly less than 40 ms. In this respect, the above-mentioned method according to the invention allows for the detection of a work progress substantially for all of the above-named applications and a screw connection for loose as well as fixed fastening elements in the fastening beam.

With the present invention, it is possible to omit as far as possible more complex methods of signal processing such as, for example, filters, signal loopbacks, system models (static as well as adaptive), and signal tracking.

Moreover, these methods allow for even faster identification of percussive operation and/or work progress, which can be used in order to induce an even faster reaction of the tool. This applies in particular to the number of past strikes after the percussive mechanism has been started until identification and even in special operating situations, such as the start-up phase of the drive motor. No limitations on the functionality of the tool, for example a reduction of the maximum drive speed, must be made. Furthermore, the algorithm also functions independently of other influencing variables, such as target speed and battery charge.

In principle, no additional sensor technology (e.g. accelerometer) is necessary, nevertheless these evaluation methods can also be applied to signals of further sensor technology. Furthermore, in other motor concepts, which do not require speed detection, for example, this method can also be used with other signals.

In a preferred embodiment, the hand-held power tool is a cordless screwdriver, a drill, a percussive drill, or a drill hammer, wherein a drill, a drill crown, or various bit attachments can be used as the tool. The hand-held power tool according to the invention is in particular configured as a percussive screwdriver, wherein a higher peak torque for a screw-in or screw-out of a screw or a screw nut is generated by the impulsive release of the motor energy. In this context, the transmission of electrical energy is to be understood in particular to mean that the hand-held power tool transmits energy to the body via a battery and/or via a power cable connection.

In addition, depending on the selected embodiment, the screwdriver can be flexible in the direction of rotation. In this way, the proposed method can be used in order to both screw-in and screw-out a screw and a screw nut, respectively.

In the context of the present invention, “ascertaining” is meant to include in particular measuring or receiving, wherein “recording” is understood in the sense of measuring and storing, and “ascertaining” also includes possible signal processing of a measured signal.

Furthermore, “deciding” should also be understood as recognizing or detecting, wherein a clear allocation is to be achieved. “Identifying” means a detection of a partial match with a pattern, which can be enabled, for example, by a fitting of a signal to the pattern, a Fourier analysis, or the like. The “partial match” is to be understood such that the fitting has a fault that is less than a specified threshold, in particular less than 30%, quite in particular less than 20%.

Further features, possible applications, and advantages of the invention emerge from the following description of the embodiment example of the invention, which is shown in the drawing. It should be noted that the features described or depicted in the figures themselves or in any combination thereof describe the subject-matter of the invention irrespective of their summary in the claims or their reverse relationship, as well as irrespective of their formulation or illustration in the specification or drawing and have only a descriptive character and are not intended to restrict the invention in any way.

### DRAWINGS

The invention is explained in further detail in the following with reference to preferred embodiment examples. The drawings are schematic and show:

FIG. 1 a schematic illustration of a hand-held power tool;

FIG. 2a a work progress of an exemplary application as well as an assigned signal of an operational variable;

FIG. 2b a match of the operational variable signal shown in FIG. 2a with a model signal;

FIG. 3a a schematic flowchart of the invention according to a first embodiment;

FIG. 3b a schematic flowchart of the invention according to a second embodiment;

FIG. 4 a work progress of an exemplary application as well as two assigned signals of operational variables;

FIG. 5 curves of signals of an operational variable according to two embodiments of the invention;

FIG. 6 curves of signals of an operational variable according to two embodiments of the invention;

FIG. 7 a work progress of an exemplary application as well as two assigned signals of operational variables;

FIG. 8 curves of signals of two operational variables according to two embodiments of the invention;

FIG. 9 curves of signals of two operational variables according to two embodiments of the invention;

FIG. 10 a schematic illustration of two different records of the signal of the operational variable;

FIG. 11a a signal of an operational variable;

FIG. 11b an amplitude function of a first frequency contained in the signal of FIG. 11a;

FIG. 11c an amplitude function of a second frequency contained in the signal of FIG. 11a;

FIG. 12 a common illustration of a signal of an operational variable and an output signal of a band-pass filtering based on a model signal;

FIG. 13 a common illustration of a signal of an operational variable and an output of a frequency analysis based on a model signal;

FIG. 14 a common illustration of a signal of an operational variable and a model signal for parameter estimation;

FIG. 15 a common illustration of a signal of an operational variable and a model signal for the cross-correlation;

FIG. 16a a schematic flowchart of the invention according to a first alternative embodiment;

FIG. 16b a schematic flowchart of the invention according to a second alternative embodiment;

FIG. 17 curves of signals of two operational variables according to an embodiment of the invention.

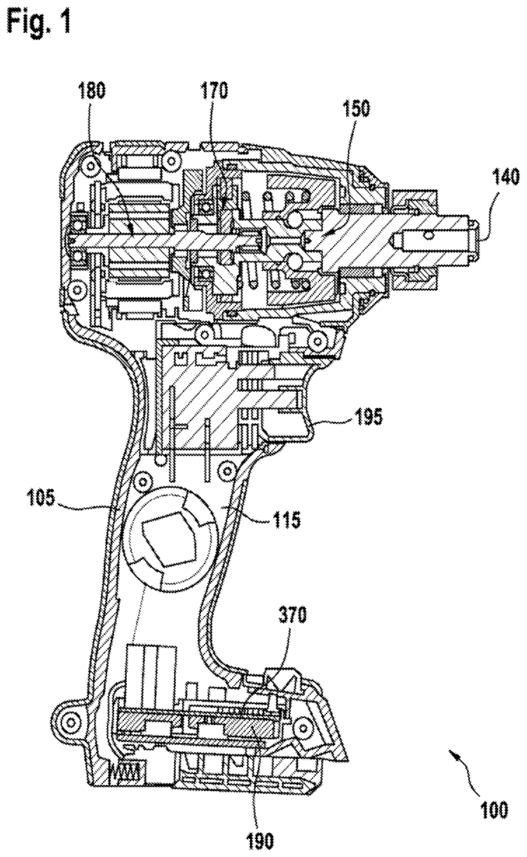

FIG. 1 shows a hand-held power tool 100 according to the invention having a housing 105 with a handle 115. According to the embodiment shown, the hand-held power tool 100 is mechanically and electrically connectable to a battery pack 190 for off-grid power supply. In FIG. 1, the hand-held power tool 100 is configured by way of example as a battery-operated percussive screwdriver. It is noted, however, that the present invention is not limited to rechargeable percussive screwdrivers, but in principle can find application in hand-held power tools 100 where it is necessary to detect a work progress, such as percussive drills.

A powered electric motor 180 and a transmission 170 from the battery pack 190 are arranged within the housing 105. The electric motor 180 is connected to an input spindle via the transmission 170. Furthermore, a control unit 370 is arranged within the housing 105 in the region of the battery pack 190, which influences the electric motor 180 and the transmission 170 by means of, for example, a set motor speed n, a selected rotational pulse, a desired transmission gear x, or the like.

For example, the electric motor 180 is actuatable, i.e. switchable, via a hand switch 195, and can be any type of motor, for example, an electronically commutated motor or a DC motor. Generally, the electric motor 180 is electronically controllable such that both a reversing operation and specifications regarding the desired motor speed n and the desired rotational pulse can be implemented. The functionality and construction of a suitable electric motor are sufficiently known from the prior art, so that a detailed description is omitted here for the purpose of shortening the description.

A toolholder 140 is rotatably supported in the housing 105 via an input spindle and an output spindle. The toolholder 140 serves to receive a tool and can be directly integrally formed on the output spindle and connected thereto in a cap-like manner.

The control unit 370 is in communication with a power source and is configured so as to electronically controllably drive the electric motor 180 using various current signals. The various current signals provide for different rotational pulses of the electric motor 180, wherein the current signals are directed to the electric motor 180 via a control line. For example, the power source can be configured as a battery or, as in the illustrated embodiment example, as a battery pack 190 or as a mains connection.

Furthermore, controls not shown in detail can be provided in order to adjust various modes of operation and/or the direction of rotation of the electric motor 180.

According to one aspect of the invention, there is provided a method for operating a hand-held power tool 100, by means of which a work progress, for example of the hand-held power tool 100 shown in FIG. 1, can be ascertained in an application, for example a screw-in or screw-out operation, and in which corresponding machine-side triggered reactions or routines are triggered as a result of this determination. This allows reliable, reproducible screw-in and screw-out operations of high quality to be achieved. Aspects of the method are based, among other things, on an examination of signal waveforms and a determination of a degree of matching of these signal waveforms, which can correspond, for example, to an evaluation of a further rotation of an element driven by the hand-held power tool 100, such as a screw.

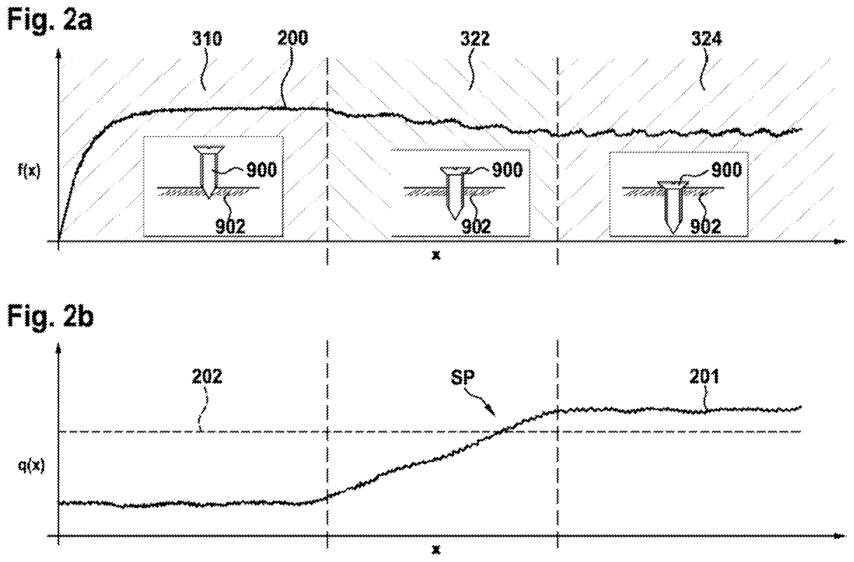

In FIG. 2, an exemplary signal of an operational variable 200 of an electric motor 180 of a percussive screwdriver, as occurs identically or similarly when using a percussive screwdriver as intended, is shown in this regard. While the following statements relate to a percussive screwdriver, they also apply mutatis mutandis in the context of the invention to other hand-held power tools 100, for example, percussive drills.

In the present example of FIG. 2, the time is plotted on the abscissa x as a reference variable. However, in an alternative embodiment, a variable correlated with time is plotted as a reference variable, such as the angle of rotation of the toolholder 140, the angle of rotation of the electric motor 180, an acceleration, a jerking, in particular of a higher order, a power, or an energy. On the ordinate f(x) in the figure, the motor speed n present at each time point is plotted. Instead of the motor speed, another operational variable correlating to the motor speed can also be selected. In alternative embodiments of the invention, for example, f(x) represents a signal of motor current.

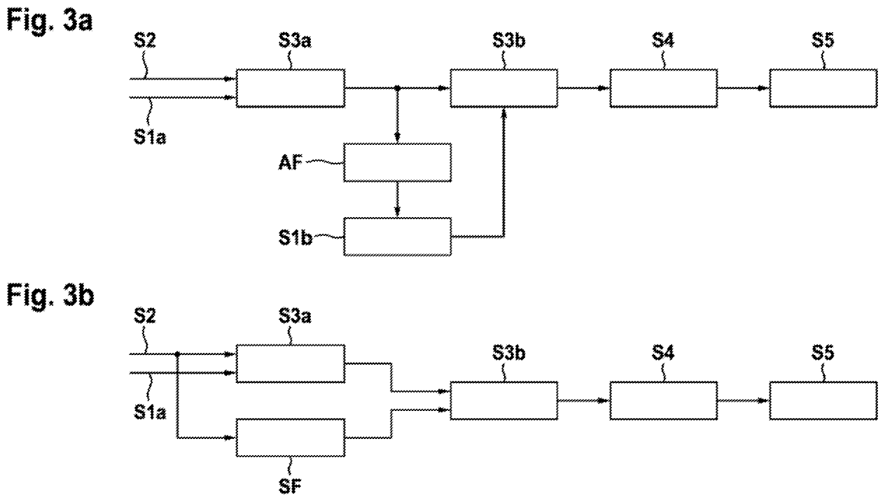

Motor speed and motor current are operational variables that are typically sensed by a controller 370 on hand-held power tools 100, without any additional effort. The ascertaining of the signal of an operational variable 200 of the electric motor 180 is characterized as method step S2 in FIG. 3, which shows a schematic flowchart of a method according to the invention. In preferred embodiments of the invention, a user of the hand-held power tool 100 can select on the basis of which operational variable the inventive method is to be carried out.

In FIG. 2a, an application case of a loose fastening element, for example a screw 900, is shown in a fastening beam 902, for example a wooden board. It can be seen in FIG. 2(a) that the signal comprises a first region 310 characterized by a monotonic increase in motor speed, as well as a range of comparatively constant motor speed, which can also be referred to as a plateau. The intersection point between abscissa x and ordinate f(x) in FIG. 2a corresponds to the start of the percussive screwdriver during the screwing operation.

In the first region 310, the screw 900 encounters a relatively low resistance in the fastening beam 902, and the torque required for screwing is below the disengagement torque of the rotary percussive mechanism. The curve of the motor speed in the first region 310 thus corresponds to the operating state of the screw without percussion.

As can be seen in FIG. 2a, the head of the screw 900 in the region 322 does not rest on the fastening beam 902, which means that the screw 900 driven by the percussive screwdriver is continually rotated with each strike. This additional rotary angle can decrease as the working operation proceeds, which is reflected in the figure by a smaller period duration. In addition, a further screwing can also be shown by a decreasing rotational speed on average.

If the head of the screw 900 subsequently reaches the support 902, an even higher torque and thus more percussive energy is necessary for further screwing in. However, because the hand-held power tool 100 no longer provides percussive energy, the screw 900 no longer rotates, or only by a significantly smaller rotational angle.

The rotary percussive operation carried out in the second 322 and third region 324 is characterized by an oscillating curve of the signal of the operational variable 200, wherein the shape of the oscillation can be trigonometric or otherwise oscillating, for example. In the present case, the oscillation has a curve which can be referred to as a modified trigonometric function. This characteristic shape of the signal of the operational variable 200 in the percussive screwing operation results from the drawing up and free-running of the percussive mechanism striker and the system chain located between the percussive mechanism and the electric motor 180, among others, of the transmission 170.

The qualitative signal waveform of the percussive operation is thus generally known due to the inherent characteristics of the rotary percussive screwdriver. In the method of FIG. 3a according to the invention, comparative information is provided in a step S1 based on this finding, comprising in step S1a the provision of at least one condition-typical model signal waveform 240, wherein the condition-typical model signal waveform 240 is associated with a working step, for example the reaching of the head of the screw 900 to rest on the fastening beam 902. In other words, the condition-typical model signal waveform 240 contains typical characteristics for the work progress such as the presence of a vibration curve, vibration frequencies or amplitudes, or individual signal sequences in continuous, quasi-continuous, or discrete form.

In other applications, the work progress to be detected can be characterized by other signal waveforms than vibrations, such as by discontinuities or growth rates in the function f(x). In such cases, the condition-typical model signal waveform is characterized by precisely these parameters, rather than vibrations.

In a preferred embodiment of the inventive method, in method step S1a, the condition-typical model signal waveform 240 can be defined by a user. The condition-typical model signal waveform 240 can also be stored or deposited in the device. In an alternative embodiment, the condition-typical model signal waveform can alternatively and/or additionally be provided to the hand-held power tool 100, for example, from an external data device. In further embodiments, the model signal waveform 240 can also be selected and provided based on a match signal, which will be described later below.

The comparative information further includes a threshold of the match provided in a step S1b. This is discussed in further detail below.

In a method step S3a of the method according to the invention, the signal of the operational variable 200 of the electric motor 180 is compared to the condition-typical model signal waveform 240, and a match signal is ascertained from the comparison. The feature “comparing” is to be interpreted broadly and in the sense of a signal analysis in the context of the present invention, so that a result of the comparison can in particular also be a partial or gradual match of the signal of the operational variable 200 of the electric motor 180 to the condition-typical model signal waveform 240, wherein the degree of matching of the two signals can be ascertained by various mathematical methods, which will be mentioned later. In particular, ascertaining the match signal can comprise ascertaining an appropriately defined error between the model signal and the operational variable signal. In other embodiments, ascertaining the match signal can comprise ascertaining a simple difference between the model signal and the operational variable signal.

According to the present invention, the match signal is automatically evaluated, which is indicated in the AF field of FIG. 3a, and used in order to provide the comparative information, i.e. the model signal waveform and/or the threshold of the match, characterized in FIG. 3a by step S1b. In embodiments of the invention, the automatic evaluation of the match signal includes ascertaining a characteristic of the match signal, in particular a gradient, a curvature, or a local or global minimum or maximum of the match signal. In this context, the term evaluation is intended to include the known means of the curve discussion and the numerical methods used for this purpose, in particular those of numerical differential and integral calculation.

In embodiments of the invention, the threshold of the match is determined based at least partly on the characteristic of the match signal, for example, when falling below a particular gradient of the match signal as a time curve or as a curve over an operation variable of the electric motor that correlates with time.

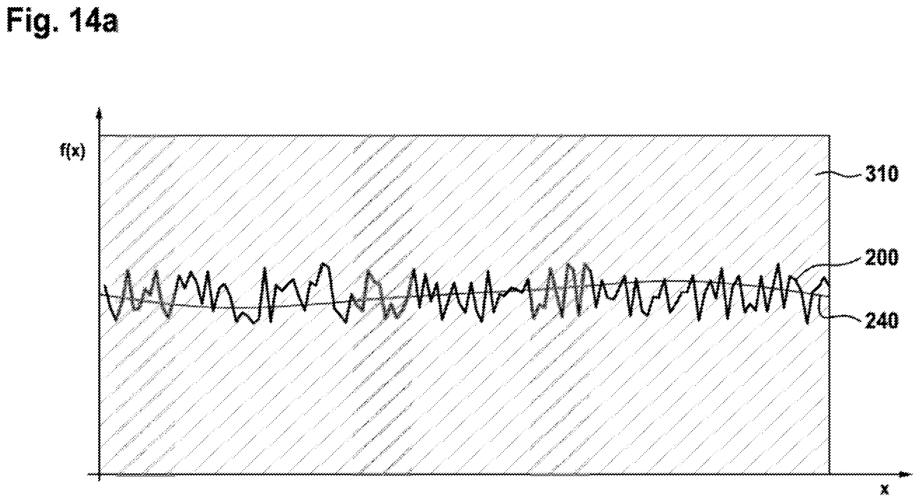

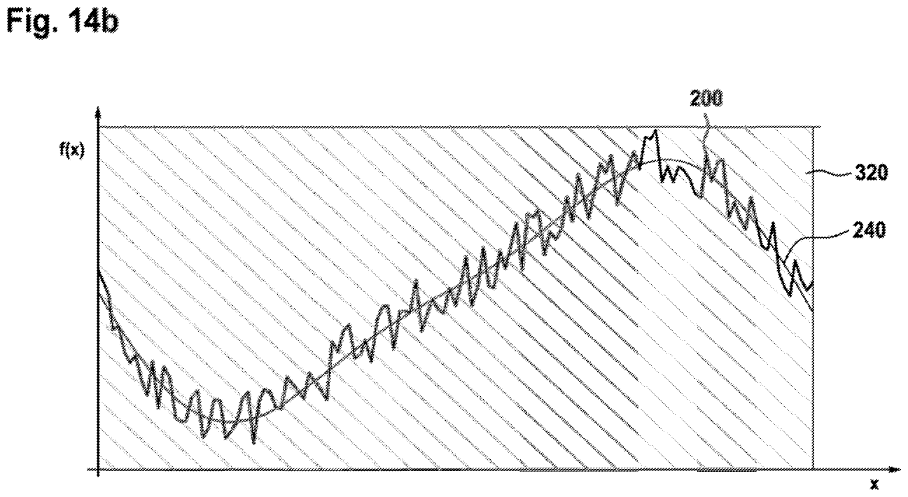

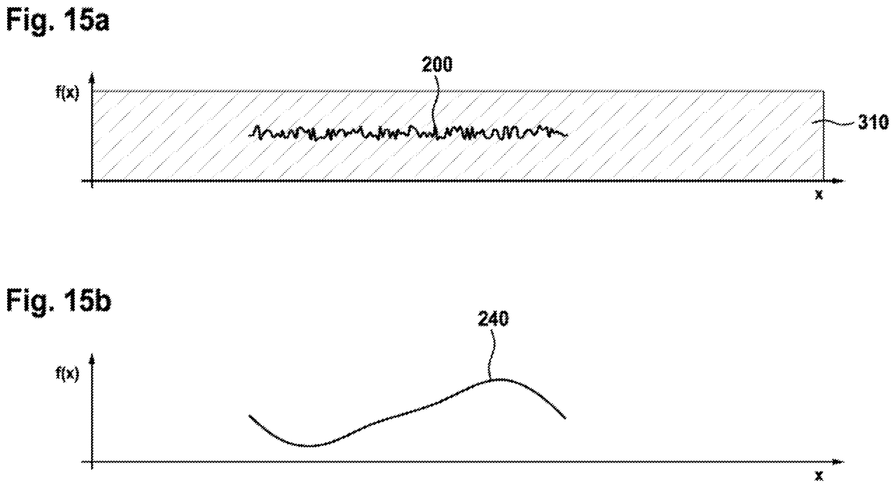

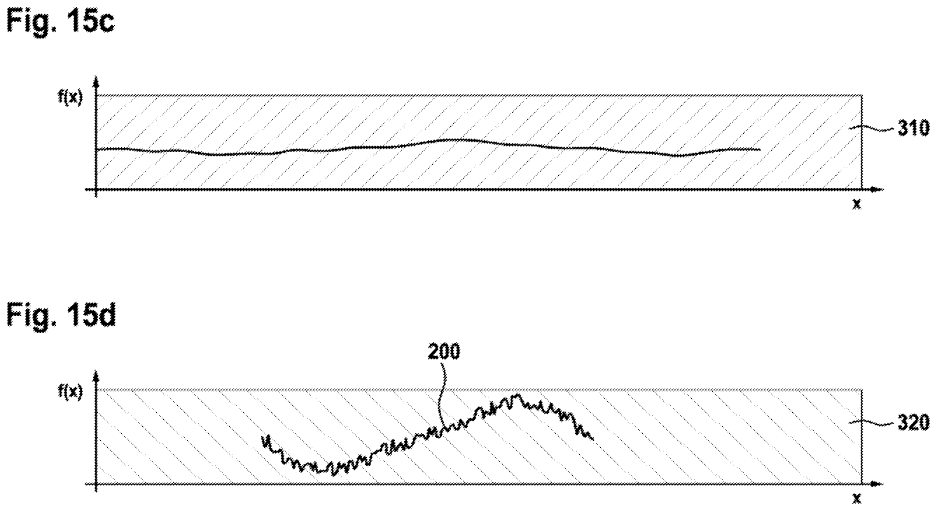

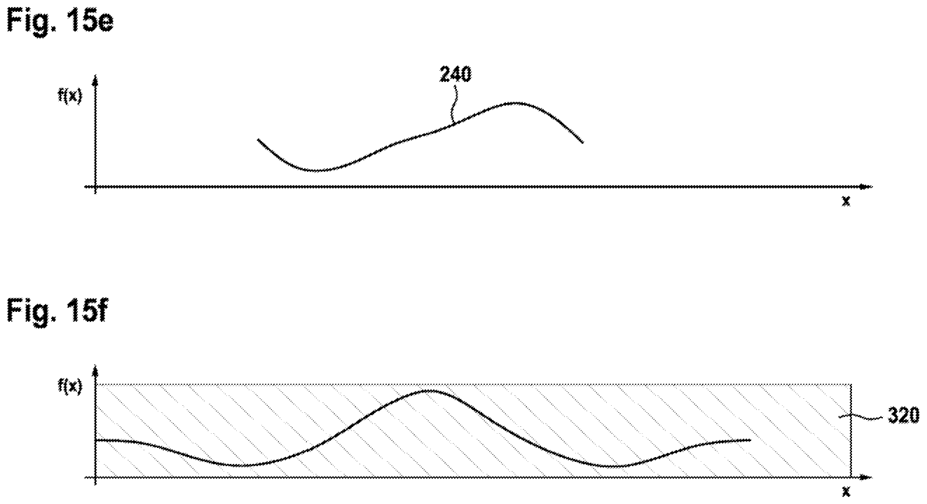

In certain embodiments, the match signal serves as the basis for selecting and providing a new model signal waveform 240 (see FIGS. 14b, 15b, 15e). This generates an additional gain in information about the current screwing operation.

In step S3b, a match evaluation of the signal of the operational variable 200 of the electric motor 180 is also ascertained from the comparison to the condition-typical model signal waveform 240, and thus a conclusion about the matching of the two signals is made. In this case, the match evaluation is carried out at least partly on the basis of the threshold of the match.

In certain embodiments, for example as shown in FIG. 3b, the match evaluation in step S3b also occurs based at least partly on a frequency of the signal of the operational variable. In this embodiment, in addition to the match signal, the frequency of the measured speed signal is additionally measured, for example in percussive operation, which is marked as SF in FIG. 3b. This frequency varies during the screwing operation, so it can be used in order to detect a work progress of the hand-held power tool, for example the end of a screwing case, with the aid of the match signal, and to trigger a suitable motor response.

In the embodiment shown in FIG. 3b, the match evaluation in step S3b is based at least partly on a logical linkage of the match signal and the frequency of the signal of the operational variable, for example an “AND,” “AND NOT,” or “OR” link.

In a further embodiment, the match evaluation in step S3b is based at least partly on a sum signal of the match signal and the frequency of the signal of the operational variable.

In a further embodiment, the match evaluation in step S3b can be ascertained at least partly based on blurred amounts or belonging functions (weight functions), cf. fuzzy logic.

FIG. 2b shows a curve of a function q(x) of a match evaluation 201 corresponding to the signal of the operational variable 200 of FIG. 2a, which indicates a value of the match between the signal of the operational variable 200 of the electric motor 180 and the condition-typical model signal waveform 240 at each location of the abscissa x.

In the present example of the screwing in of the screw 900, this evaluation is used in order to determine the extent of continued rotation for one strike. In the example, the condition-typical model signal waveform 240 provided in step S1 corresponds to an ideal strike without further rotation, that is to say, the state in which the head of the screw 900 rests on the surface of the fastening beam 902, as shown in region 324 of FIG. 2a. Accordingly, in the region 324, there is a high matching of the two signals, which is reflected by a consistently high value of the function q(x) of the match evaluation 201. In the region 310, on the other hand, in which each strike is associated with high rotational angles of the screw 900, only small match values are achieved. The less the screw 900 continues to rotate in the strike, the higher this match, which can be seen from the fact that the function q(x) of the match evaluation 201 already reflects continuously increasing match values when the percussive system in the region 322 is started, which is characterized by a continuously smaller rotational angle of rotation of the screw 200 due to the increasing screw-in resistance.

In a method step S4 of the method according to the invention, the working step is now at least partly detected based on the match evaluation 201 ascertained in method step S3b. As can be seen in the example of FIG. 2, the match evaluation 201 of the signals for percussive differentiation is well-suited for this due to its more or less abrupt characteristic, wherein this abrupt change is due to the also more or less abrupt change in the further rotational angle of the screw 900 when completing the exemplary operation. For example, detecting work progress can be done at least partly by comparing the match evaluation 201 to the threshold of match, which is indicated by a dashed line 202 in FIG. 2b. In the present example of FIG. 2b, the intersection point SP of the function q(x) of the match evaluation 201 with line 202 is associated with the work progress of abutting the head of the screw 900 on the surface of the fastening beam 902.

According to the present invention, by distinguishing signal waveforms, an evaluation of the continued rotation of an element driven by a percussive screwdriver can be made in order to ascertain the progress of an application.

Despite the resulting reduction in speed when switching the operating state to percussive operation, it is very difficult to prevent the screw head from penetrating the material, for example in case of small wooden screws or self-tapping screws. This is because the strikes of the percussive system result in a high spindle speed, even with increasing torque.

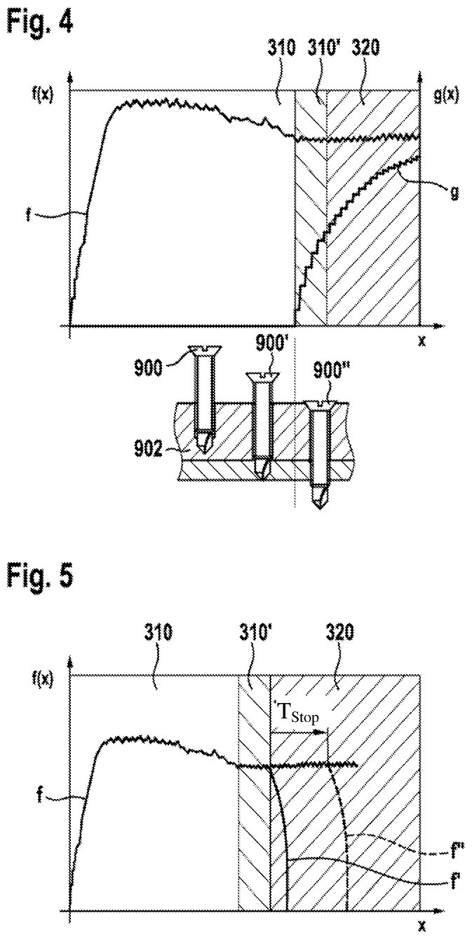

This behavior is shown in FIG. 4. As in FIG. 2, time is plotted on the abscissa x, for example, while a motor speed is plotted on the ordinate f(x), and torque g(x) is plotted on the ordinate g(x). Accordingly, graphs f and g indicate the curves of the motor speed f and the torque g over time. In the lower region of FIG. 4, again similar to the illustration of FIG. 2, schematically different states are shown in a screwing operation of a wooden screw 900, 900′, and 900″ into a fastening beam 902.

In the “No strike” operating state represented in the figure by reference number 310, the screw rotates at high speed f and low torque g. In the operating state “strike,” characterized by reference number 320, the torque g increases rapidly, while the speed f only drops slightly, as noted above. The region 310′ in FIG. 3 denotes the region within which the percussive detection explained in connection with FIG. 2 takes place.

For example, to prevent a screw head of the screw 900 from entering the fastening beam 902, according to the present invention, in a method step S5 shown in FIG. 3a, an application-based, appropriate routine or reaction of the tool is carried out based at least partly on the work progress detected in method step S4, a shutdown of the machine, a change in speed of the electric motor 180, and/or an optical acoustic, and/or haptic feedback to the user of the hand-held power tool 100.

In one embodiment of the invention, the first routine comprises the stopping of the electric motor 180, taking into account at least one parameter that is defined and/or specifiable, in particular specifiable by a user of the hand-held power tool.

For example, in FIG. 5, a stopping of the device directly after the percussive detection 310′ is shown schematically, whereby the user is assisted in avoiding a penetration of the screw head into the fastening beam 902. In the figure, this is represented by the rapidly decreasing branch f of graph f downstream of the region 310′.

An example of a defined and/or specifiable parameter, in particular specifiable by a user of the hand-held power tool 100, is a user-defined time after which the device stops, which is shown in FIG. 5 by the time period Tₛₜₒₚ, as well as the associated branch f″ of the graph f. Ideally, the hand-held power tool 100 stops precisely so that the screw head is flush with the screw support surface. However, because the time until this occurs is different from case to case, it is advantageous when the time period Tₛₜₒₚ can be defined by the user.

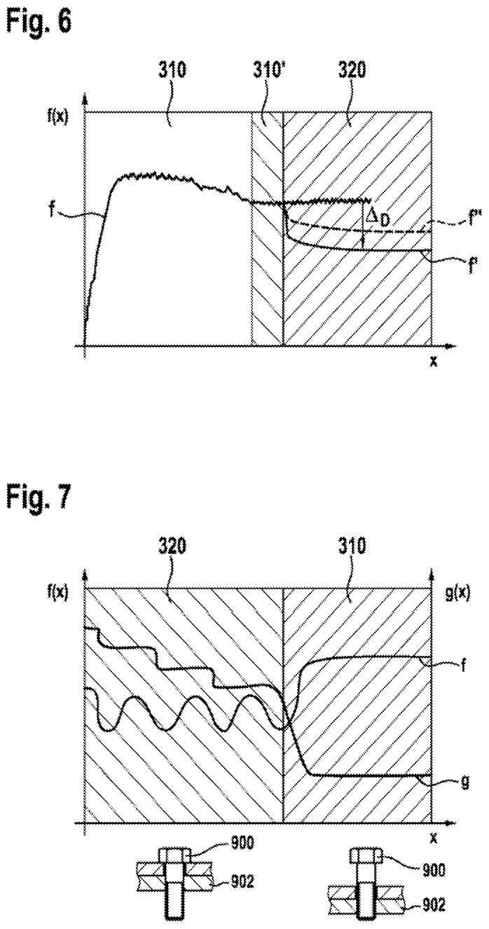

Alternatively or additionally, in an embodiment of the invention, it is conceivable that the first routine includes a change, in particular a reduction and/or an increase, of a speed, in particular a desired speed, of the electric motor 180 and thus also the spindle speed after percussive detection. The embodiment in which a reduction in speed is carried out is shown in FIG. 6. Again, the hand-held power tool 100 is initially operated in the “No strike” operating state 310, characterized by the motor speed curve represented by graph f. In the example, after percussive detection has occurred in the region 310′, the motor speed is reduced by a certain amplitude, which is represented by graphs f and f″, respectively.

The amplitude or height of the change in speed of the electric motor 180, for which the branch f′ of the graph f in FIG. 6 is characterized by the Δ_{D}, can be adjusted by the user in an embodiment of the invention. By lowering the speed, the user will have more time to respond as the screw head approaches the surface of the fastening beam 902. As soon as the user feels that the screw head is flush enough to the support surface, the user can use the switch to stop the hand-held power tool 100. Compared to stopping the hand-held power tool 100 after percussive detection, the change in motor speed, in the example of FIG. 6, has the advantage that, by user-determined shutdown, this routine is largely independent of the application case.

In an embodiment of the invention, the amplitude Δ_{D} of the changing of the speed of the electric motor 180 and/or a target value of the speed of the electric motor 180 can be defined by a user of the hand-held power tool 100, which again increases the flexibility of this routine in terms of applicability for a wide variety of applications.

The change in speed of the electric motor 180 occurs repeatedly and/or dynamically in embodiments of the invention. In particular, the change of speed of the electric motor 180 can be staggered in time and/or taken along a characteristic of the change in speed, and/or depending upon the work progress of the hand-held power tool 100.

Examples of such include, but are not limited to, combinations of speed reduction and speed increase. In addition, various routines or combinations thereof can be carried out with a time offset for percussive detection. Furthermore, the invention also includes embodiments in which an offset in time between two or more routines is provided. For example, if the motor speed is reduced directly after percussive detection, the motor speed can also be increased again after a certain time value. Embodiments are also provided in which not only different routines themselves, but also the time offset between the routines is specified by a characteristic curve.

As noted above, the invention includes embodiments in which the work progress is characterized by a change from operating state “strike” in a region 320 to the operating state “no strike” in a region 310, which is illustrated in FIG. 7.

Such a transition of the operating states of the hand-held power tool is given, for example, in a working step in which a screw 900 comes loose from a fastening beam 902, i.e. in a screw-out operation, which is shown schematically in the lower portion of FIG. 7. As in FIG. 4, in FIG. 7, graph f represents the speed of the electric motor 180, and graph g represents the torque.

As already explained in connection with other embodiments of the invention, the operating state of the craft machine is also detected here with the aid of finding characteristic signal waveforms, in the present case the operating state of the percussive mechanism.

In the operating state “strike,” i.e. in the region 320 in FIG. 7, the screw 900 does not rotate, and a high torque g is given. In other words, the spindle speed in this state is equal to zero. In the operating state “no strike,” i.e. in FIG. 7 in the region 310, the torque g drops down quickly, which in turn provides an equally rapid increase in the spindle and motor speed f. Due to this rapid increase in motor speed f, caused by the decrease in torque g from the time the screw 900 is loosened from the fastening beam 902, it is often difficult for the user to intercept the loosening screw 900 or nut and prevent it from falling down.

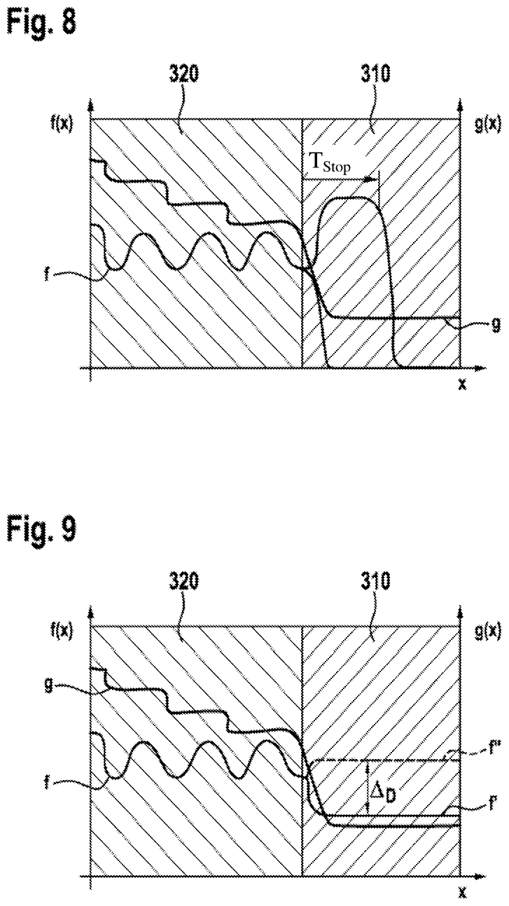

The method according to the present invention can be used in order to prevent a threaded means, which can be a screw 900 or a nut, from being unscrewed so quickly after release from the fastening beam 902 that it falls down. Reference is made to FIG. 8 in this regard. With regard to the depicted axes and graphs, FIG. 8 corresponds essentially to FIG. 7, and corresponding reference numbers refer to corresponding characterizing features.

In a first embodiment, in step S5, the routine includes stopping the hand-held power tool 100 directly after it is ascertained that the hand-held power tool 100 is operating in the “No strike” operating mode, which is shown in FIG. 8 by a steeply decreasing branch f of the graph f of the motor speed in the region 310. In alternative embodiments, a time Tₛₜₒₚ, can be defined by the user, after which the device stops. In the figure, this is represented by the branch f′ of the graph f of the motor speed. The person skilled in the art recognizes that the motor speed as also shown in FIG. 7 initially increases rapidly after transitioning from the region 320 (operational state “strike”) to the region 310 (operational state “no strike”) and drops sharply after the end of the period Tsp.

If the appropriate time period Tsp is selected, it is possible that the motor speed falls to “zero” precisely when the screw 900 or nut has been threaded. In this case, the user can remove the screw 900 or nut with a few turns of the thread, or alternatively leave it in the thread in order to open a clamp, for example.

A further embodiment example of the invention will now be described in the following with reference to FIG. 9. In this case, after transition from the region 320 (operating state “strike”) to the region 310 (operating state “no strike”), the motor speed is reduced. The amplitude or height of the reduction is indicated in the figure with Δ_{D} as a measure between a mean f′ of the motor speed in the region 320 and the decreased motor speed f. This drop can be adjusted by the user in certain embodiments, particularly by indicating a target value of the speed of the hand-held power tool 100 that is at the level of the branch f in FIG. 9.

By lowering the motor speed and thus also the spindle speed, the user has more time to react when the head of the screw 900 detaches from the screw support surface. Once the user believes that the screw head or nut has been screwed far enough, the switch can be used in order to stop the hand-held power tool 100.

Compared to the embodiments described in connection with FIG. 8, in which the hand-held power tool 100 is stopped directly or at a delay after transition from the region 320 (operational state “strike”) to the region 310 (operational state “no strike”), the speed reduction has the advantage of further independence from the application case, because ultimately the user determines when the hand-held power tool is switched off after the speed reduction. This can be helpful, for example, in case of long threaded rods. Here, there are applications in which a more or less long unscrewing process must be carried out after the threaded rod has been detached and the associated suspension of the percussive mechanism has occurred. Thus, switching off the hand-held power tool 100 after the percussive mechanism has been suspended would not be appropriate in these cases.

In some embodiments of the invention, a work progress is output to a user of the hand-held power tool using an output apparatus of the hand-held power tool.

Some technical correlations and embodiments regarding the performance of the method steps S1-S4 will now be explained below.

In practical applications, it can be provided that method steps S2, S3a, and S3b can be carried out repeatedly during operation of a hand-held power tool 100 in order to monitor the progress of the executed application. For this purpose, in method step S2, a segmentation of the ascertained signal of the operational variable 200 can be carried out, so that the method steps S2 and S3 are carried out on signal segments, preferably always of the same defined length.

For this purpose, the signal of the operational variable 200 can be stored in a memory, preferably a ring memory, as a result of measured values. In this embodiment, the hand-held power tool 100 comprises the memory, preferably the ring memory.

As already mentioned in connection with FIG. 2, in preferred embodiments of the invention, in method step S2, the signal of the operational variable 200 is ascertained as a time curve of measured values of the operational variable, or as measured values of the operational variable as a variable of the electric motor 180 correlating to the time curve. The measured values can be discrete, quasi-continuous, or continuous.

One embodiment provides that the signal of the operational variable 200 is incorporated in method step S2 as a time curve of measured values of the operational variable and, in a method step S2a following method step S2, there is a transformation of the time curve of the measured values of the operational variable into a curve of the measured values of the operational variable as a variable of the electric motor 180 that correlates to the time curve, such as the rotational angle of the toolholder 140, the motor rotational angle, an acceleration, a jerking, in particular of a higher order, a power, or an energy.

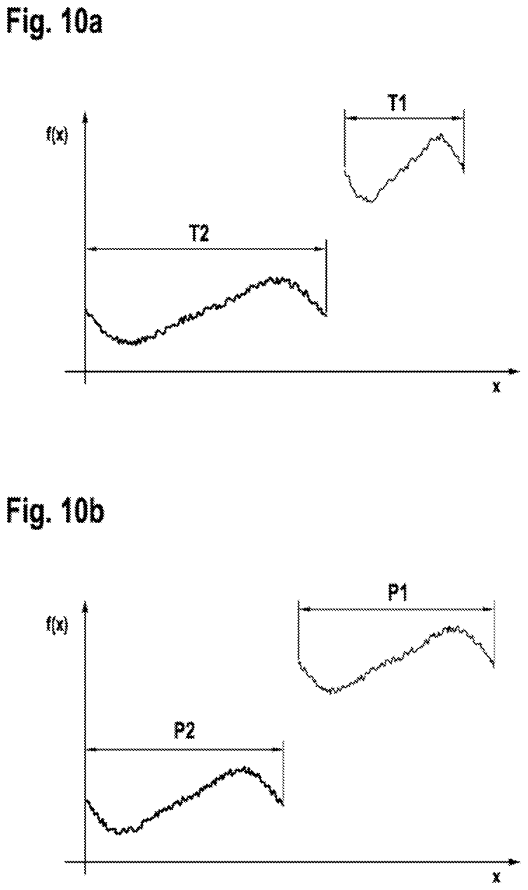

The advantages of this embodiment will be described below with reference to FIG. 10. Similar to FIG. 2, FIG. 10a shows signals f(x) of an operational variable 200 over an abscissa x, in this case over the time t. As in FIG. 2, the operational variable can be a motor speed or a parameter correlating to the motor speed.

The figure contains two signal curves of the operational variable 200, which can be respectively assigned to one working step, i.e. in the case of a rotary percussive screwdriver, for example, to the rotary percussive screw mode. In both cases, the signal comprises a wavelength of an idealized vibration curve assumed to be sinusoidal, wherein the shorter wavelength signal, T1, has a curve with higher strike frequency and the longer wavelength signal, T2, has a curve with a lower strike frequency.

Both signals can be generated with the same hand-held power tool 100 at different motor speeds, and are dependent on, among other things, which revolution speed the user requests from the hand-held power tool 100 via the user switch.

If, for example, the parameter “wavelength” is now to be used in order to define the condition-typical model signal waveform 240, at least two different wavelengths T1 and T2 would have to be stored as possible parts of the condition-typical model signal waveform for the present case, so that the comparison of the signal of the operational variable 200 with the condition-typical model signal waveform 240 in both cases leads to the result “Matching”. Because the motor speed can change generally and to a large extent over time, this also causes the wavelength sought to vary, thereby requiring the methods for detecting this strike frequency to be adjusted adaptively accordingly.

With a plurality of possible wavelengths, the effort of the method and programming would increase accordingly.

Thus, in the preferred embodiment, the time values of the abscissa are transformed into values correlating to the time values, such as acceleration values, jerking values of a higher order, power values, energy values, frequency values, rotational angle values of the toolholder 140, or rotational angle values of the electric motor 180. This is possible because the rigid gear ratio of the electric motor 180 to the percussive mechanism and the toolholder 140 results in a direct, known dependence of motor speed on the frequency of percussive. This normalization achieves a vibration signal of consistent periodicity independent of the motor speed, which is shown in FIG. 10b by the two signals belonging to T1 and T2, wherein both signals now have the same wavelength P1=P2.

Accordingly, in this embodiment of the invention, the condition-typical model signal waveform 240 can be validly ascertained for all speeds by a single parameter of the wavelength above the variable correlated to time, such as the rotational angle of the toolholder 140, the motor rotational angle, an acceleration, a jerking, in particular of a higher order, a power, or an energy.

In a preferred embodiment, the comparison of the signal of the operational variable 200 in method step S3a is carried out with a comparison method, wherein the comparison method comprises at least one frequency-based comparison method and/or one comparative comparison method. The comparison method compares the signal of the operational variable 200 with the condition-typical model signal waveform 240 too ascertain whether at least the threshold of the match is met. The frequency-based comparison method comprises at least band-pass filtering and/or frequency analysis. The comparative comparison method comprises at least the parameter estimate and/or the cross-correlation. The frequency-based and comparison methods will be described in further detail below.

In band-pass filtering embodiments, optionally as described, the input signal is filtered to a variable that correlates to the time via one or more band-passes that match the pass-through regions of one or more condition-typical model signal waveforms. The pass-through region results from the condition-typical model signal waveform 240. It is also conceivable that the pass-through region will match a frequency established in connection with the condition-typical model signal waveform 240. In the event that amplitudes of this frequency exceed a specified limit value, as is the case when the work progress to be detected is reached, the comparison in method step S3b then results in the outcome that the signal of the operational variable 200 is the same as the condition-typical model signal waveform 240 and that the work progress to be detected is thus achieved. Determining an amplitude threshold can be considered in this embodiment as ascertaining the match evaluation of the condition-typical model signal waveform 240 with the signal of the operational variable 200, on the basis of which it is decided whether the work progress to be detected is present or not in method step S4.

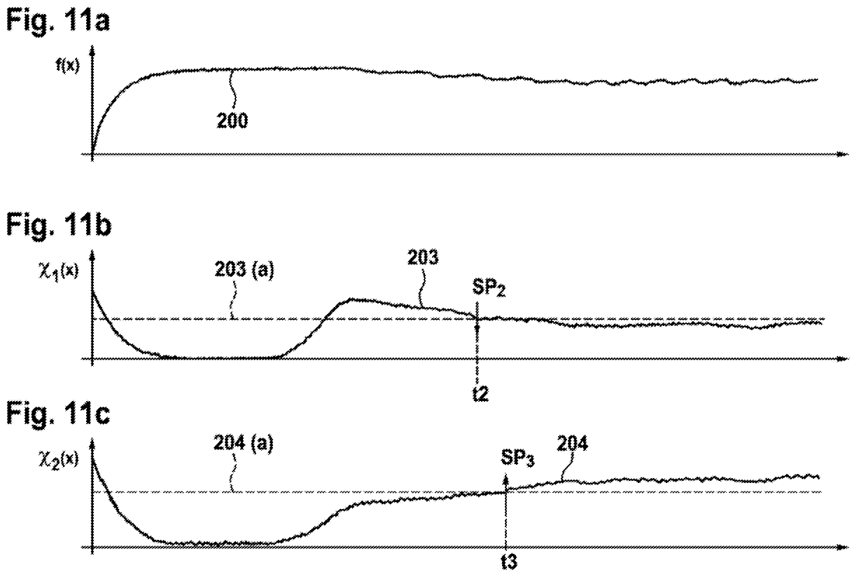

Based on FIG. 11, the embodiment is to be explained in which frequency analysis is used as a frequency-based comparison method. In this case, the signal of the operational variable 200 shown in FIG. 1 a, for example corresponding to the progression of the speed of the electric motor 180 over time, is transformed from a time range to the frequency range with corresponding weighting of the frequencies based on the frequency analysis, for example the fast Fourier transformation (FFT). In this respect, the term “time range” according to the above statements is to be understood both as a “course of the operational variable over time” as well as a “course of the operational variable as a variable correlating with time”.

The frequency analysis in this characteristic is well known as a mathematical tool for signal analysis from many regions of technology and is used, among other things, to approximate measured signals as serial developments of weighted periodic, harmonic functions of different wavelengths. In FIGS. 11b and 11c, for example, weighting factors κ₁(x) and κ₂(x) as functional curves 203 and 204 indicate over time whether and how much the corresponding frequencies or frequency bands, which are not specified at this point for the sake of clarity, are present in the investigated signal, i.e. the progression of the operational variable 200.

With respect to the method according to the invention, it can be ascertained whether and at what amplitude the frequency associated with the condition-typical model signal waveform 240 is present in the signal of the operational variable 200 using the frequency analysis. Moreover, however, frequencies can also be defined whose absence is a measure of the progress of work to be detected. As mentioned in the context of band-pass filtering, a limit value of the amplitude can be established, which is a measure of the degree of matching of the signal of the operational variable 200 to the condition-typical model signal waveform 240.

In the example of FIG. 11b, for example, at time t₂ (point SP₂), the amplitude κ₁(x) of a first frequency, which is typically not found in the signal of the operational variable 200 in the condition-typical model signal 240, falls below an associated threshold 203(a), which in the example is a necessary but insufficient criterion for the existence of the work progress to be detected. At time t₃ (point SP₃), the amplitude κ₂(x) of a second frequency typically found in the condition-typical model signal waveform 240 in the signal of the operational variable 200, exceeds an associated threshold 204(a). In the associated embodiment of the invention, the common presence of falling short of or exceeding the limit values 203(a), 204(a) due to the amplitude functions κ₁(x) and κ₂(x), respectively, is the relevant criterion for the evaluation of the matching of the signal of the operational variable 200 to the conditional model signal waveform 240. Accordingly, in this case, it is ascertained in method step S4 that the work progress to be detected is achieved.

In alternative embodiments of the invention, only one of these criteria is used, or combinations of either or both criteria are used with other criteria, for example achieving a desired speed of the electric motor 180.

In embodiments of the method according to the invention in which the parameter estimate is used as a comparative comparison method, the measured signal of the operational variables 200 is compared to the condition-typical model signal waveform 240, wherein estimated parameters are identified for the condition-typical model signal waveform 240. Using the estimated parameters, a measure of the matching of the measured signal of the operational variables 200 to the condition-typical model signal waveform 240 can be ascertained as to whether the work progress to be detected has been achieved. The parameter estimate is based on the compensatory calculation, which is a mathematical optimization method known to the person skilled in the art. The mathematical optimization method, using the estimated parameters, allows the condition-typical model signal waveform 240 to match a series of measurement data of the signal of the operational variable 200.

Depending on a measure of matching of the model signal waveform 240 parameterized by the estimated parameters and a threshold, the decision as to whether the work progress to be detected is achieved can be made.

Using the compensatory calculation of the comparison method of parameter estimation, a measure of a matching of the estimated parameters of the condition-typical model signal waveform 240 to the measured signal of the operational variable 200 can also be ascertained.

In one embodiment of the inventive method, the method of cross-correlation is used as the comparative comparison method in the method step S3. Like the mathematical methods described above, the method of cross-correlation is known to the person skilled in the art. In the cross-correlation method, the condition-typical model signal waveform 240 is correlated to the measured signal of the operational variable 200.

Compared to the method of parameter estimation presented above, the result of the cross-correlation is again a signal sequence with an added signal length from a length of the signal of the operational variable 200 and the condition-typical model signal waveform 240, which represents the similarity of the time-offset input signals. The maximum of this output sequence represents the time of the highest match of the two signals, i.e. the signal of the operational variable 200 and the condition-typical model signal waveform 240, and is thus also a measure for the correlation itself, which is used in this embodiment in method step S4 as a decision criterion for achieving the work progress to be detected. In the implementation in the method according to the invention, a significant difference compared to the parameter estimate is that any of the state-typical model signal waveforms can be used for the cross-correlation, while in the parameter estimate, the state-typical model signal waveform 240 must be represented by parameterizable mathematical functions.

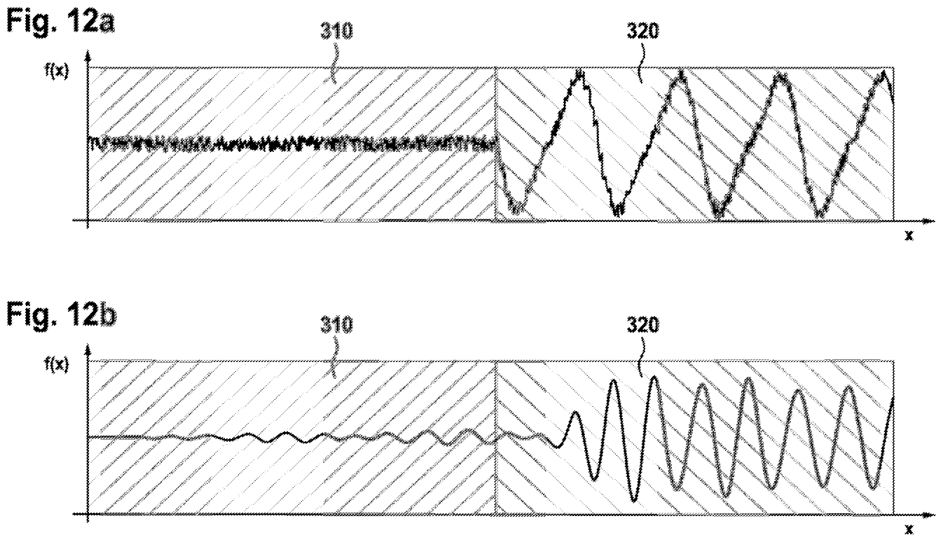

FIG. 12 shows the measured signal of the operational variable 200 in the event that band-pass filtering is used as the frequency-based comparison method. Herein, the time or a variable correlating to time is plotted as abscissa x. FIG. 12a shows the measured signal of the operational variable as the input signal of the band-pass filtering, wherein in the first region 310 the hand-held power tool 100 is operated in screw operation. In the second region 320, the hand-held power tool 100 is operating in a rotary percussive operation. FIG. 12b shows the output signal after the band-pass has filtered the input signal.

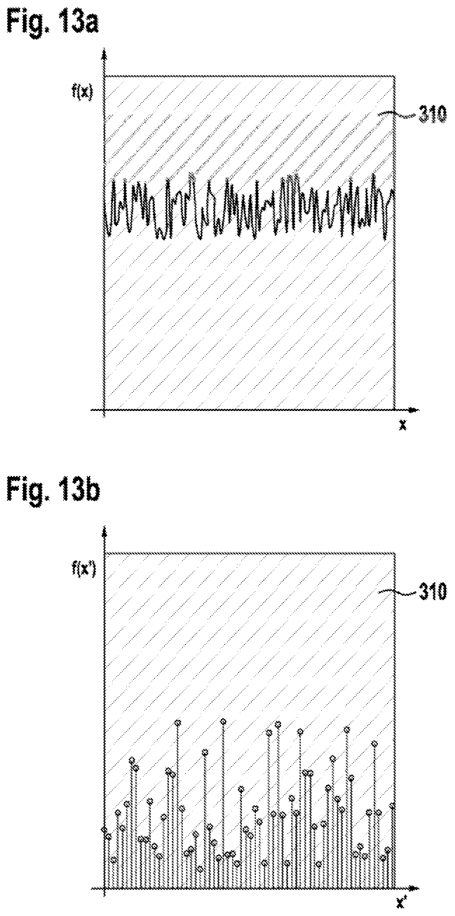

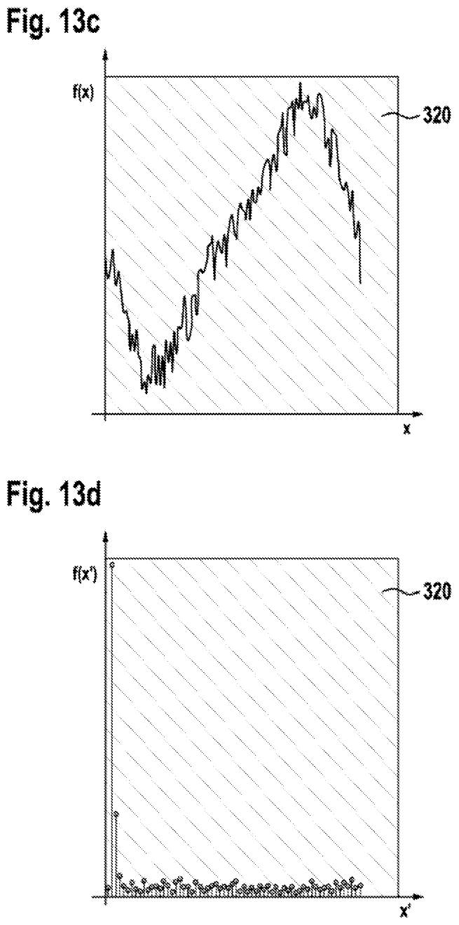

FIG. 13 shows the measured signal of the operational variable 200 in the event that the frequency analysis is used as the frequency-based comparison method. FIGS. 13a and b show the first region 310 in which the hand-held power tool 100 is in screwing operation. On the abscissa x of FIG. 13a, the time t or a variable correlated to time is plotted. In FIG. 13b, the signal of the operational variable 200 is shown transformed, wherein, for example, by means of a fast Fourier transformation, it can be transformed from a time range into a frequency range. For example, the frequency f is plotted on the abscissa x′ of FIG. 13b so that the amplitudes of the signal of the operational variable 200 are represented. FIGS. 13c and d show the second region 320 in which the hand-held power tool 100 is in rotary percussive operation. FIG. 13c shows the measured signal of the operational variable 200 plotted over time in the rotary percussive operation. FIG. 13d shows the transformed signal of the operational variable 200, wherein the signal of the operational variable 200 is plotted via the frequency f as an abscissa x′. FIG. 13d shows characteristic amplitudes for the rotary percussive operation.

FIG. 14 shows a typical case of a comparison using the comparative comparison method of parameter estimation between the signal of an operational variable 200 and a condition-typical model signal waveform 240 in the first region 310 described in FIG. 2. While the model signal waveform 240 typical of the state has a substantially trigonometric curve, the signal of the operational variable 200 has a curve that is greatly different therefrom. Regardless of the choice of one of the comparison methods described above, in this case the comparison carried out in method step S3a between the condition-typical model signal waveform 240 and the signal of the operational variable 200 results in the degree of matching of the two signals being so low that the work progress to be detected is not detected in method step S4.

In FIG. 14b, on the other hand, the case is shown in which the work progress to be detected is given and therefore the model signal waveform 240 and the signal of the operational variable 200 have a high overall degree of matching, even if deviations can be detected at individual measurement points. Thus, in the comparison method of parameter estimation, the decision as to whether the work progress to be detected has been achieved can be made.

FIG. 15 shows the comparison of the condition-typical model signal waveform 240, see FIGS. 15b and 15e, with the measured signal of the operational variable 200, see FIGS. 15a and 15d, in the event that the cross-correlation is used as the comparison method. In FIGS. 15a-f, the time or a variable correlating to time is plotted on the abscissa x. FIGS. 15a-c show the first region 310 corresponding to the screwing operation. FIGS. 15d-f show the third region 324 corresponding to the work progress to be detected. As described further above, the measured signal of the operational variable, FIG. 15a and FIG. 15d, is correlated to the condition-typical model signal waveform, FIGS. 15b and 15e. The respective results of the correlations are shown in FIGS. 15c and 15f. In FIG. 15c, the result of the correlation during the first region 310 is shown, wherein it is discernible that there is a low matching of the two signals. In the example of FIG. 15c, it is therefore decided in method step S4 that the work progress to be detected is not achieved. In FIG. 15f, the result of the correlation during the third region 324 is shown. It can be seen in FIG. 15f that there is a high matching, so that in method step S4 it is decided that the work progress to be detected is achieved.

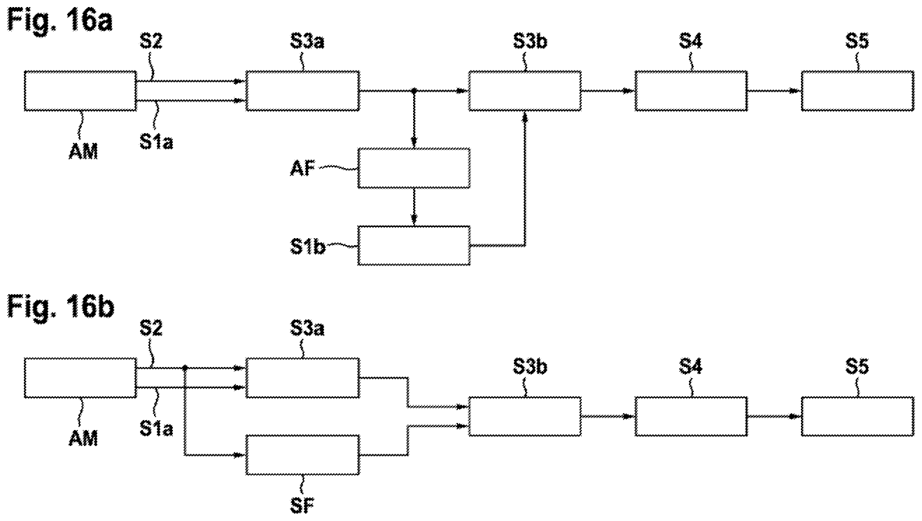

FIG. 16a shows a schematic flowchart of the invention according to a first alternative embodiment. The flowchart in FIG. 16a differs from the flowchart described in FIG. 3a in that method step S1 is preceded by a method step AM. In the method step AM, an upper speed limit of the electric motor 180 is set. The upper speed limit can be set in a range of 20% to 100% of a maximum speed of the electric motor 180. In method step S5, the first routine comprises adjusting a speed value of the electric motor 180 and keeping the speed value substantially constant. Here, the speed value for a further screwing in of the screw element is kept substantially constant. The speed value here is factory-set, wherein alternatively the user can set the speed value. In addition, the method step S5 comprises in the first routine the time period Tₛₜₒₚ being set by the user.

FIG. 16b shows a schematic flowchart of the invention according to a second alternative embodiment. The flowchart in FIG. 16b differs from the flowchart described in FIG. 3b in that method step S1 is preceded by method step AM. Again, the first routine of method step S5 comprises adjusting the speed value of the electric motor 180 and keeping the speed value substantially constant. In addition, in the first routine, the time period Tₛₜₒₚ, is also set by the user here.

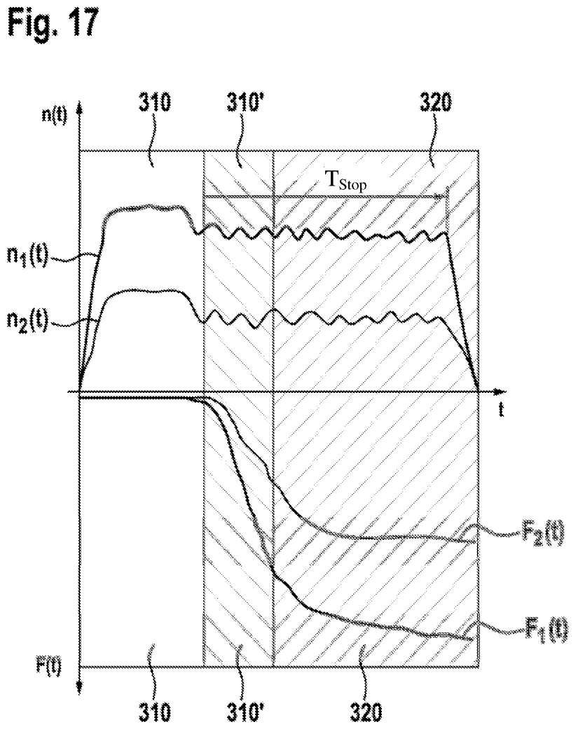

FIG. 17 shows curves of signals of two operational variables according to one embodiment of the invention. The curves are divided into the region 310, no percussive, the region 310′, percussive detection, and the region 320, percussive operation. The curves are plotted over a time t. In so doing, a first ordinate shows the speed n(t) of the electric motor 180. A first speed graph n₁(t) shows a curve of the speed n(t) at a maximum speed of the electric motor 180. Also, for the first speed graph n₁(t), the time period Tₛₜₒₚ, is set by the user. A second speed graph n₂(t) shows a history of the speed at a set upper speed limit. The upper speed limit is here in a range of 20% to 100% of the maximum speed of the electric motor 180. The upper speed limit is set by the user. A second ordinate shows a screw biasing force or tightening torque F(t) of screwing elements. A first screw biasing force graph F₁(t) shows a curve of the screw biasing force F(t) at the maximum speed of the electric motor 180. A second screw biasing force graph F₂(t) shows a curve of the screw biasing force F(t) at the set upper speed limit.

The invention is not limited to the embodiment example described and illustrated. Rather, it also encompasses all further developments by an expert within the scope of the invention as defined by the claims.

In addition to the described and illustrated embodiments, further embodiments are conceivable, which can include further modifications as well as combinations of features.

1. A method for operating a hand-held power tool, the hand-held power tool having an electric motor, the method comprising:
(S1) providing comparative information, having the steps of:
(S1a) providing at least one model signal waveform, said model signal waveform being assignable to a work progress of the hand-held power tool, and
(S1b) providing a threshold of a match;
(S2) ascertaining a signal of an operational variable of the electric motor;
(S3) analyzing the comparative information and the signal of an operational variable, having the method steps of:
(S3a) comparing the signal of the operational variable with the model signal waveform and ascertaining a match signal from the comparison, and
(S3b) ascertaining a match evaluation, said match evaluation being carried out at least partly using the threshold of the match and using the match signal; and
(S4) detecting the work progress at least partly using the match evaluation ascertained in step (S3),
wherein said comparative information being provided at least partly on the basis of an automatic evaluation of the match signal.

2. The method according to claim 1, wherein the evaluation of the match signal at least partly includes ascertaining a gradient of the match signal.

3. The method according to claim 2, wherein the threshold of the match is determined at least partly on the basis of the gradient of the match signal.

4. The method according to claim 1, wherein the match evaluation in method step (S3b) is carried out at least partly using a frequency of the signal of the operational variables as a function of a frequency threshold.

5. The method according to 4, wherein the match evaluation in method step (S3b) is carried out at least partly on the basis of a logical linkage of the match signal and the frequency of the signal of the operational variable.

6. The method according to claim 5, wherein the match evaluation in method step (S3b) is carried out at least partly on the basis of a sum signal of the match signal and the frequency of the signal of the operational variable.

7. The method according to claim 1, wherein the operational variable is a speed of the electric motor or an operational variable correlating to the speed.

8. The method according to claim 1, further comprising:
(s5) executing a first routine of the hand-held power tool based at least partly on the work progress detected in method step (S4).

9. The method according to claim 8, wherein the first routine includes a reduction and/or an increase of a speed of the electric motor.

10. The method according to claim 9, wherein an amplitude of the change in the speed of the electric motor and/or a target value of the speed of the electric motor (is configured to be defined by a user of the hand-held power tool.

11. The method according to claim 9, wherein the change in the speed of the electric motor occurs staggered over time and/or along a characteristic curve of the speed change and/or as a function of the work progress of the hand-held power tool.

12. The method according to claim 8, wherein the first routine comprises an adjustment of a speed value of the electric motor and a substantial constant maintenance of the speed value.

13. The method according to claim 8, wherein the first routine and/or characteristic parameters of the first routine is configured to be adjusted and/or displayed by a user via an application software (“app”) or a user interface (“human-machine interface,” “HMI”).

14. The method according to claim 1, further comprising:
(AM) setting a upper speed limit of the electric motor.

15. The method according to claim 1, wherein a work progress is output to a user of the hand-held power tool using an output apparatus of the hand-held power tool.

16. The method according to claim 1, wherein the model signal waveform is a substantially trigonometric vibration curve.

17. The method according to claim 1, wherein the signal of the operational variable is incorporated in method step (S2) as a time curve of measured values of the operational variable, or as measured values of the operational variable as a variable of the electric motor correlated with the time curve.

18. The method according to claim 1, wherein the signal of the operational variable is incorporated in method step (S2) as a time curve of measured values of the operational variable and, in a method step (S2a) following the method step (S2), there is a transformation of the time curve of the measured values of the operational variable into a curve of the measured values of the operational variable as a variable of the electric motor correlated with the time curve.

19. The method according to claim 1, wherein the comparison of the signal of the operational variable to the model signal waveform includes at least one frequency-based comparison method and/or one comparative comparison method.

20. The method according to claim 1, wherein the hand-held power tool is a rotary percussive screwdriver, and the work progress is a start or end of a rotary percussive operation.

21. (canceled)
